(19) United States
(12) Patent Application Publication
(10) Pub. No.: US 2008/0297875 A1
(43) Pub. Date: Dec. 4, 2008

(54) PIEZOELECTRIC DRIVING DEVICE AND METHOD THEREOF AND OPTICAL MODULATING DEVICE USING THE SAME

(75) Inventors: Seung-Do An, Suwon-si (KR); Anatoliy Lapchuk, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/128,565

(22) Filed: May 28, 2008

(30) Foreign Application Priority Data
Jun. 1, 2007 (KR) 10-2007-0053749

(51) Int. Cl. G02B 26/08; H02N 2/06; G02F 1/29

(52) U.S. Cl. 359/224; 359/298; 310/317

(57) ABSTRACT

Disclosed are a piezoelectric driving device and a driving method thereof, and an optical modulating device using the same. In accordance with an embodiment of the present invention, the optical modulating device can include an optical modulator, having a piezoelectric element causing a displacement object to be displaced by being contracted or expanded according to a supplied driving voltage; and a driving unit, generating the driving voltage to be supplied to the piezoelectric element. Here, the driving voltage can be a square-wave signal having a shorter reset time than a minimum reaction time necessary to allow the displacement object to be displaced.

### CROSS-REFERENCE TO RELATED PATENT APPLICATIONS

This application claims the benefit of Korean Patent Application No. 10-2007-0053749, filed on Jun. 01, 2007, in the Korean Intellectual Property Office, the disclosure of which is incorporated herein in its entirety by reference.

### BACKGROUND OF THE INVENTION

1. Field of the Invention

The present invention relates to a piezoelectric element, more specifically to a piezoelectric driving device and a method thereof, and an optical modulating device using the same that can use a square-wave signal having a shorter reset time than a minimum reaction time necessary to change the position of a displacement object as a driving voltage in order to drive a piezoelectric element.

2. Background Art

A piezoelectric element refers to a micromachine which provides a driving force for causing the displacement of an object desired to be displaced (hereinafter, referred to as a displacement object) by using a piezoelectric material contracted or expanded according to a supplied driving voltage. The piezoelectric element is extensively used for various micro electro mechanical system (MEMS) devices such as scanning microscopes, optical probes, optical modulators and data storing devices.

The relationship between the supplied driving voltage and the corresponding displacement has the hysteresis as shown in FIG. 1. As such, the hysteresis of the piezoelectric is caused by the polarization hysteresis related to the piezoelectric effect of a piezoelectric element according to the supplied driving voltage (i.e. the contraction or expansion according to the polarization of a piezoelectric layer). This will be described below by focusing on FIG. 1 and with reference to FIG. 2 and FIG. 3. Here, FIG. 2 shows the conventional step-shaped driving voltage supplied to a piezoelectric element, and FIG. 3 shows a displacement caused by a displacement object displaced according to the hysteresis of a piezoelectric element to which the driving voltage of FIG. 2 is supplied.

Referring to the hysteresis curves of a piezoelectric element of FIG. 1, in the case of supplying gradually increased driving voltage to the piezoelectric element, the position of the replacement object is changed according to a first hysteresis curve 11. In the case of supplying gradually decreased driving voltage to the piezoelectric element, the position of the replacement object is changed according to a second hysteresis curve 12. In other words, the relationship between the voltage and the displacement caused by the hysteresis of the piezoelectric element (i.e. the polarization hysteresis) has different characteristics for an increasing direction and a decreasing direction.

Accordingly, if a step-shaped driving voltage of FIG. 2 is supplied, even though a driving voltage having the same magnitude is supplied to the piezoelectric element, the displacement of the displacement object has different values according to whether the increased driving voltage or the decreased driving voltage is supplied.

Referring to FIG. 2 and FIG. 3, even through the driving voltage V₂ having the same magnitude is supplied to the piezoelectric element, if the driving voltage is increased from V₁ to V₂, the displacement of the displacement object corresponds to S₂₁. Also, if the driving voltage is decreased from Vₘₐₓ to V₂, the displacement corresponds to S₂₂. As a result, it is recognized that the displacement of the displacement object may have different values in two cases.

Briefly, if the conventional piezoelectric element driving method by which the step-shaped driving voltage is supplied is used, even though the driving voltage having the same magnitude is supplied, the displacement of the displacement object may have different values due to the hysteresis of the piezoelectric element. This makes it impossible to give accuracy and reliability to various application devices using the piezoelectric element.

### SUMMARY OF THE INVENTION

Accordingly, the present invention provides a piezoelectric driving device and a method thereof, and an optical modulating device using the same that can allow the displacement of a displacement object not to be changed according to a supplied driving voltage and to have a constant displacement value by solving the hysteresis of the piezoelectric element.

The present invention also provides a piezoelectric driving device and a method thereof, and an optical modulating device using the same that can give accuracy and reliability to various application devices using the piezoelectric element by solving the hysteresis of the piezoelectric element.

An aspect of the present invention features an optical modulating device including an optical modulator, having a piezoelectric element causing a displacement object to be displaced by being contracted or expanded according to a supplied driving voltage; and a driving unit, generating the driving voltage to be supplied to the piezoelectric element. Here, the driving voltage can be a square-wave signal having a shorter reset time than a minimum reaction time necessary to allow the displacement object to be displaced.

Here, the piezoelectric element can include two electrodes; and a piezoelectric layer, placed between the two electrodes and contracted or expanded according to the driving voltage supplied between the two electrodes. Here, the piezoelectric layer can restore a polarization hysteresis during the reset time and have a property corresponding to any one of two polarization hysteresis curves of directions in which the driving voltage is increased and decreased.

A gray-scale voltage value of the square-wave signal can be determined as a modulation voltage value to be used for an optical modulation performed by the optical modulator.

The square-wave signal can be the square-wave signal can be reset whenever a gray-scale voltage value is changed.

The driving unit can generate the square-wave signal at regular intervals of a predetermined period and the generating period of the square-wave signal can be determined to be identical to a time that it takes for the optical modulator to perform a 1 pixel-optical-modulation.

The driving unit can generate the square-wave signal by synchronizing it with a point of time when an optical modulation is performed per pixel by the optical modulator.

The minimum reaction time necessary for a displacement of the displacement object can be 1 μs.

The optical modulating device can include a substrate; an insulation layer, placed on the substrate; a lower optical reflection layer, placed on the insulation layer and reflecting an incident beam of light; a ribbon layer, having a center part formed with a hole, the center part being away from the insulation layer at a predetermined interval; an upper optical reflection layer, placed on the center part of the ribbon layer and reflecting the incident beam of light; and the piezoelectric element, placed on the ribbon layer.

The displacement object can be is the center part of the ribbon layer.

The square-wave signal can be reset to a minimum or maximum voltage value in a range of the driving voltage supplied to the piezoelectric element.

Another aspect of the present invention features a piezoelectric driving device including a piezoelectric element, causing a displacement object to be displaced by being contracted or expanded according to a supplied driving voltage; and a driving unit, generating the driving voltage to be supplied to the piezoelectric element, whereas the driving voltage is a square-wave signal has a shorter reset time than a minimum reaction time necessary to allow the displacement object to be displaced.

Here, the square-wave signal is reset whenever a gray-scale voltage value can be changed.

The driving unit can generate the square-wave signal at regular intervals of a predetermined period.

The minimum reaction time necessary for a displacement of the displacement object can be 1 μs.

The square-wave signal can be reset to a minimum or maximum voltage value in a range of the driving voltage supplied to the piezoelectric element.

Another aspect of the present invention features a method for driving a piezoelectric driving apparatus having a piezoelectric element, which causes a displacement object to be displaced by being contracted or expanded according to a supplied driving voltage, and a driving unit, which generates the driving voltage to be supplied to the piezoelectric element, including generating a square-wave signal having a shorter reset time than a minimum reaction time necessary to allow the displacement object to be displaced; and supplying the square-wave signal to the piezoelectric element.

Here, the minimum reaction time necessary for a displacement of the displacement object can be 1 μs.

### BRIEF DESCRIPTION OF THE DRAWINGS

These and other features, aspects and advantages of the present invention will become better understood with regard to the following description, appended claims and accompanying drawings where:

FIG. 1 shows a hysteresis curve of a displacement caused by a displacement object displaced according to a driving voltage supplied to a piezoelectric element;

FIG. 2 shows the conventional step-shaped driving voltage supplied to a piezoelectric element;

FIG. 3 shows a displacement caused by a displacement object displaced according to the hysteresis of a piezoelectric element to which the driving voltage of FIG. 2 is supplied;

FIG. 4 shows the structure of a piezoelectric optical modulator which is an example of a piezoelectric driving device in accordance with the present invention;

FIG. 5 shows the structure of another piezoelectric optical modulator which is an example of a piezoelectric driving device in accordance with the present invention;

FIG. 6A and FIG. 6B show the principle for allowing an optical modulation to be performed by the piezoelectric optical modulator of FIG. 4;

FIG. 7 is a plan view showing an optical modulator array including the piezoelectric optical modulators of FIG. 4;

FIG. 8 shows an example of the structure of a color display apparatus using the optical modulator array of FIG. 7;

FIG. 9 shows a method for forming an image of 1 frame projected on a screen according to the color display apparatus of FIG.8;

FIG. 10A shows a driving voltage supplied to a piezoelectric element in accordance with an embodiment of the present invention;

FIG. 10B shows a driving voltage supplied to a piezoelectric element in accordance with another embodiment of the present invention;

FIG. 11A shows a displacement caused by a displacement object displaced by a piezoelectric element to which the driving voltage of FIG. 10A is supplied;

FIG. 11B shows a displacement caused by a displacement object displaced by a piezoelectric element to which the driving voltage of FIG. 10B is supplied;

FIG. 12 shows the hysteresis of a piezoelectric element to which the driving voltage of FIG. 10A is supplied;

FIG. 13 is an enlarged view showing the driving voltage of FIG. 10A;

FIG. 14 and FIG. 15 show a maximum reaction time of a piezoelectric element to which a driving voltage is supplied; and

FIG. 16 and FIG. 17 show a minimum reaction time of a replacement object when a driving voltage is supplied to a piezoelectric element.

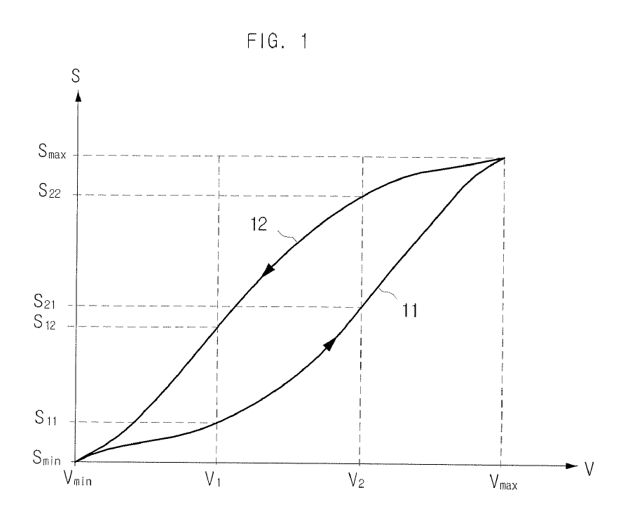

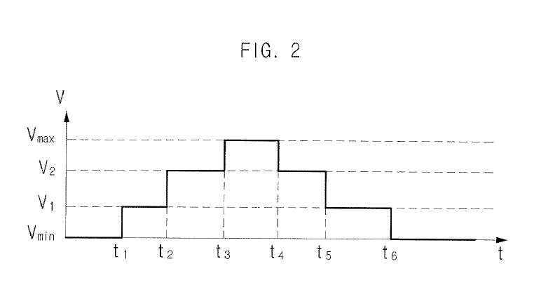

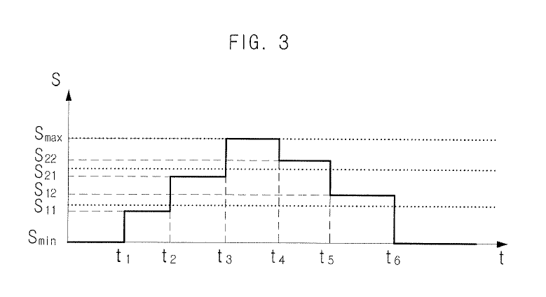

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

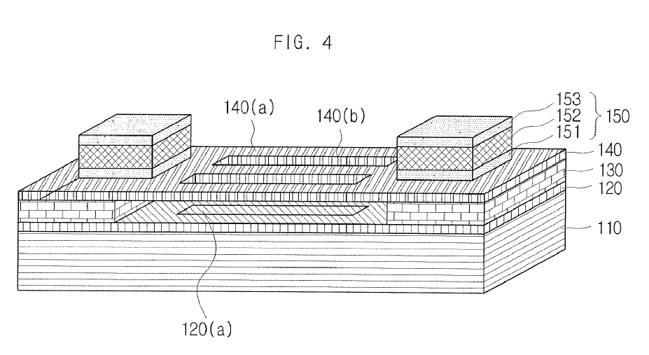

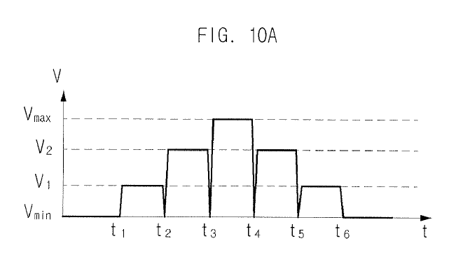

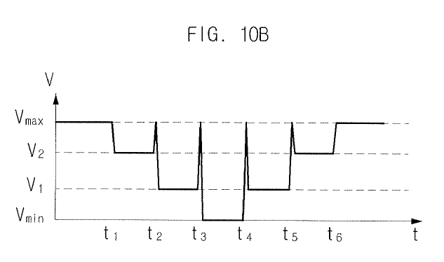

Prior to describing a piezoelectric driving device (i.e. a piezoelectric element and a driving unit) and a method thereof, and an optical modulating device (i.e. a piezoelectric optical modulator and a driving unit) in detail, an optical modulator will be described with reference to FIG. 4 through FIG. 9. Also, the below description related to a piezoelectric driving device and a method thereof by referring to FIG. 10A through FIG. 17 focuses on the case of applying to the optical modulator to be described with reference to FIG. 4 through FIG. 9.

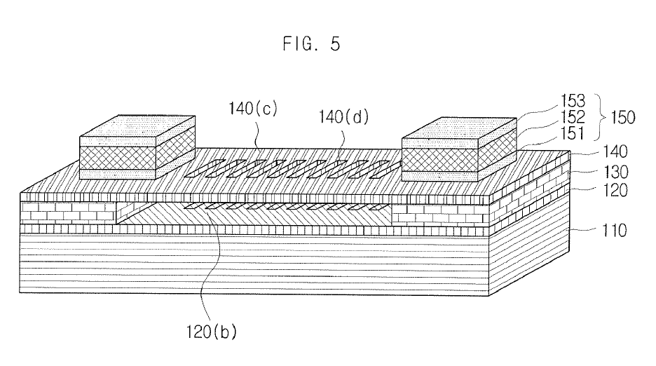

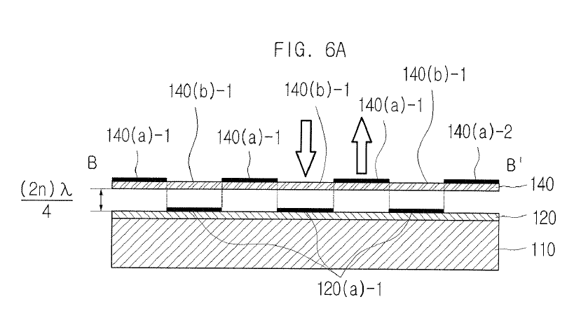

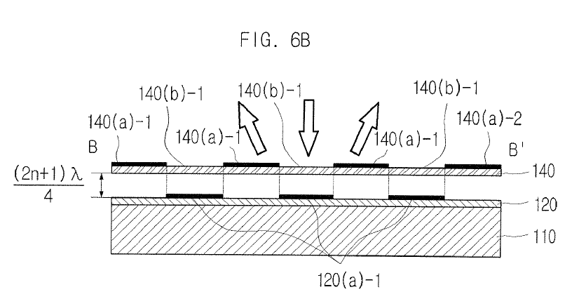

FIG. 4 shows the structure of a piezoelectric optical modulator which is an example of a piezoelectric driving device in accordance with the present invention, and FIG. 5 shows the structure of another piezoelectric optical modulator which is an example of a piezoelectric driving device in accordance with the present invention. FIG. 6A and FIG. 6B show the principle for allowing an optical modulation to be performed by the piezoelectric optical modulator of FIG. 4.

As shown in FIG. 4 and FIG. 5, the piezoelectric optical modulator can include a substrate 110, an insulation layer 120, a sacrificial layer 130, a ribbon structure 140 and a piezoelectric element 150. Here, a plurality of holes 140(b) or 140(d) can be formed in a center part of the ribbon structure 140 (hereinafter, referred to as a ribbon). Also, an upper optical reflection layer 140(a) or 140(c) can be formed in a part of the ribbon in which the holes are formed, and a lower optical reflection layer 120(a) or 120(b) can be formed in a part of the insulation layer 120 to be correspond to the position of the holes. The piezoelectric element 150 can provide a driving force allowing the ribbon to move up and down according to the level of the contraction or expansion of a piezoelectric layer 152 generated by a driving voltage supplied between two electrodes (i.e. a lower electrode 151 and an upper electrode 152).

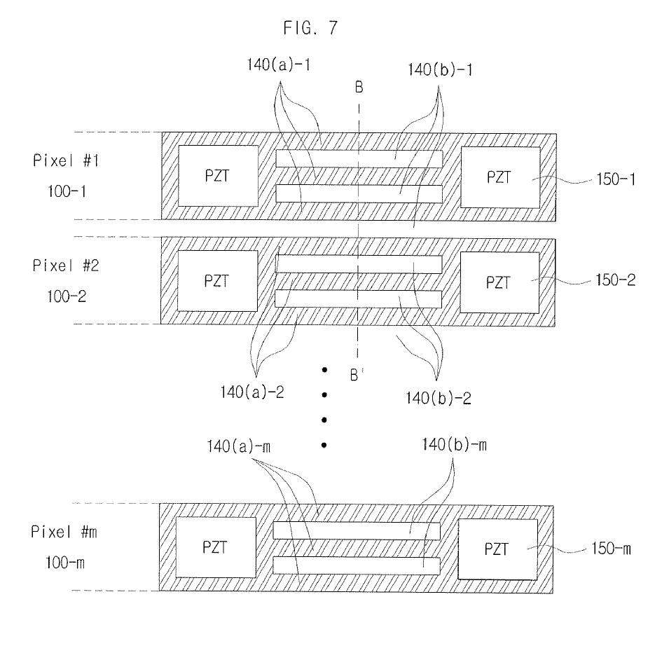

Hereinafter, the optical modulating principle of a piezoelectric optical modulator having a piezoelectric element will be described with reference to FIG. 6A and FIG. 6B. Here, FIG. 6A and FIG. 6B are a sectional view showing an optical modulator array which is cut by a line BB′ of the below-described FIG. 7.

Referring to FIG. 6A, in case that the wavelength of a beam of light incident on the optical modulator is λ, a first driving voltage can be supplied to the piezoelectric elements 150. At this time, the first driving voltage can allow the gap between the ribbon formed with the upper reflection layer 140(a) and the insulation layer 120 formed with the lower reflection layer 120(a) to be equal to (2n)λ/4, n being a natural number. In the case of a 0^{th}-order diffracted beam of light, the overall path length difference between the light reflected by the upper reflection layer 140(a) and the light reflected by the lower reflection layer 120(a) is equal to nλ, so that constructive interference occurs and the diffracted light renders its maximum luminance. In the case of +1^{st} or −1^{st} order diffracted light, however, the luminance of the light is at its minimum luminance due to destructive interference.

Referring to FIG. 6B, in case that the wavelength of a beam of light incident on the optical modulator is λ, a first driving voltage can be supplied to the piezoelectric elements 150. At this time, the first driving voltage can allow the gap between the ribbon formed with the upper reflection layer 140(a) and the insulation layer 120 formed with the lower reflection layer 120(a) to be equal to (2n+1)λ/4, n being a natural number. In the case of a 0^{th}-order diffracted beam of light, the overall path length difference between the light reflected by the upper reflection layer 140(a) and the light reflected by the lower reflection layer 120(a) is equal to (2n+1)λ/2, so that destructive interference occurs and the diffracted light renders its minimum luminance. In the case of +1^{st} or −1^{st} order diffracted light, however, the luminance of the light is at its maximum luminance due to constructive interference.

As such, the piezoelectric optical modulator can load a signal for one pixel on the beam of light by adjusting the quantity of the reflected or diffracted light by use of the result of interference of the reflected light by the upper optical reflection layer 140(a) and the lower optical reflection layer 120(a), respectively, according to the driving voltage supplied to the piezoelectric element. The above description with reference to FIG. 6A and FIG. 6B, which is related to supplying two driving voltages allowing the gap between the ribbon and the insulation layer 120 to be (2n)λ/4 or (2n+1)λ/4, can be merely an example.

Also, although the description related to FIG. 4 through FIG. 6B is concentrated on an optical modulator having a ribbon in which a plurality of holes are formed, it shall be obvious that the present invention can be applied to any piezoelectric optical modulator including a piezoelectric element, which provides a driving force allowing the ribbon as the displacement object to move up and down by being contracted or expanded according to a driving voltage supplied between each electrode to realize the optical diffraction, without restriction.

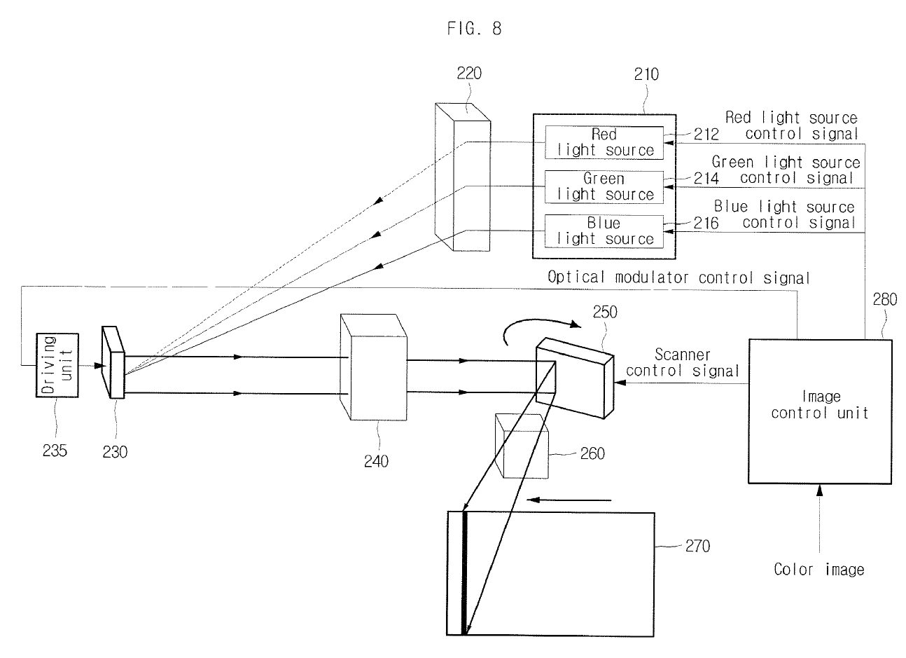

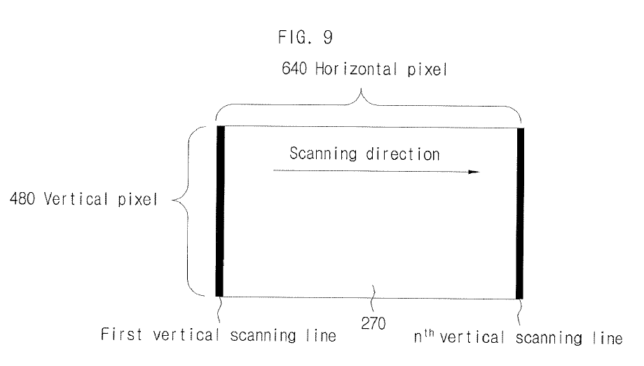

FIG. 7 is a plan view showing an optical modulator array including the piezoelectric optical modulators of FIG. 4, and FIG. 8 shows an example of the structure of a color display apparatus using the optical modulator array of FIG. 7. FIG. 9 shows a method for forming an image of 1 frame projected on a screen according to the color display apparatus of FIG. 8. Hereinafter, an example of a color display apparatus using the piezoelectric optical array of FIG. 8 will be described with reference to FIG. 7 through FIG. 9.

The color display apparatus of FIG. 8 can include a three-color light source 210, a lighting optical system 220, an optical modulator array 230, a driving unit 235, a relay optical system 240, a scanner 250, a projection optical system 260, a screen 270 and an image control circuit 280. Here, since the three-color light source 210, the lighting optical system 220, the relay optical system 240 and the projection optical system 260 pertain to typical elements of the display apparatus such as a projection apparatus, the pertinent detailed description will be omitted.

The three-color light source 210 can emit each color beam of light corresponding to predetermined control signals 212, 214 and 216. The emitted color beams of light can be incident on the optical modulator array 230 through the lighting optical system 220.

The optical modulator array 230 can have the same structure as shown in FIG. 7. In particular, the optical modulator array 230, as shown in FIG. 7, can be configured to include m micro-mirrors 100-1, 100-2, . . . , and 100-m, each of which corresponds to a first pixel (pixel #1), a second pixel (pixel #2), . . . and an m^{th} pixel (pixel #m), respectively, to thereby perform the optical modulation for forming a one-dimensional image corresponding to a vertical or horizontal scanning line. For example, if it is assumed that an image displayed on a screen has the resolution of 640 (horizontal pixel number)×480 (vertical pixel number) and the optical modulator array 230 performs the optical modulation for forming a one-dimensional image corresponding to a vertical scanning line, the optical modulator array 230 can be formed to include a total of 480 optical modulators corresponding to the vertical pixel number.

At this time, each optical modulator of the optical modulator array 230 can generate a diffraction beam of light by performing the optical modulation of the incident color beam of light according to light intensity information of each pixel. Here, the light intensity information can be transferred from the image control circuit 280 (refer to an optical modulator control signal), and the driving unit 235 can allow the optical modulator array 230 to perform the optical modulation for forming a one-dimensional image by supplying a driving voltage having a predetermined magnitude to each optical modulator (i.e. a piezoelectric element included in each modulator).

The scanner 250 can scan a modulation (or diffraction) beam of light transferred from the optical modulator array 230 on the screen 270 according to a scanner control signal transferred from the image control circuit 280. For example, the scanner 250, as shown in FIG. 9, can scan the one-dimensional image corresponding to each vertical scanning line (i.e. a first vertical scanning line through a n^{th} vertical scanning line) transferred from the optical modulator array 230.

A color image of 1 frame can be displayed on the screen 280 by performing the foregoing optical modulation and scanning of a red beam, a green beam and a blue beam of light one time each, respectively.

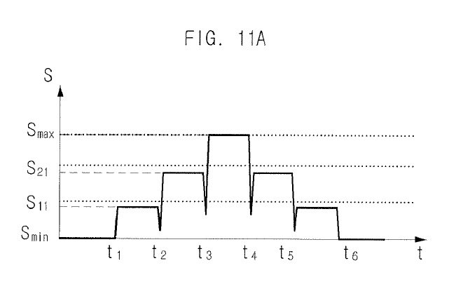

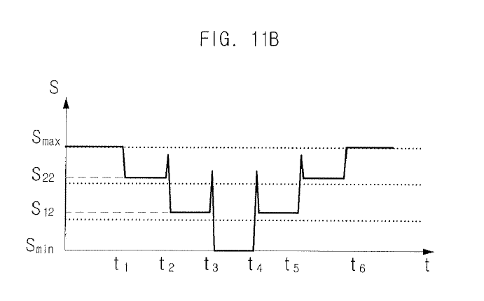

Hereinafter, the method for driving a piezoelectric driving device (and an optical modulating device using the same) in accordance with an embodiment of the present invention will be described by focusing on FIG. 10A with reference to FIG. 11A through FIG. 17.

Here, the piezoelectric driving device in accordance with an embodiment of the present invention can include a piezoelectric element (e.g. 150 of FIG. 4 through FIG. 7), which allows a displacement object to be displaced by being contracted or expanded according to a supplied driving voltage, and a driving unit (e.g. 235 of FIG. 8), which generates a driving voltage to be the piezoelectric element. The optical modulation device in accordance with an embodiment of the present invention can include a piezoelectric optical modulator (e.g. the optical modulator of FIG. 4 through FIG. 8) and the foresaid driving unit. In the below description, the piezoelectric element, the optical modulator and the driving unit have the identical reference numbers to those used in FIG. 4 through FIG. 9.

FIG. 10A shows a driving voltage supplied to a piezoelectric element in accordance with an embodiment of the present invention, and FIG. 10B shows a driving voltage supplied to a piezoelectric element in accordance with another embodiment of the present invention.

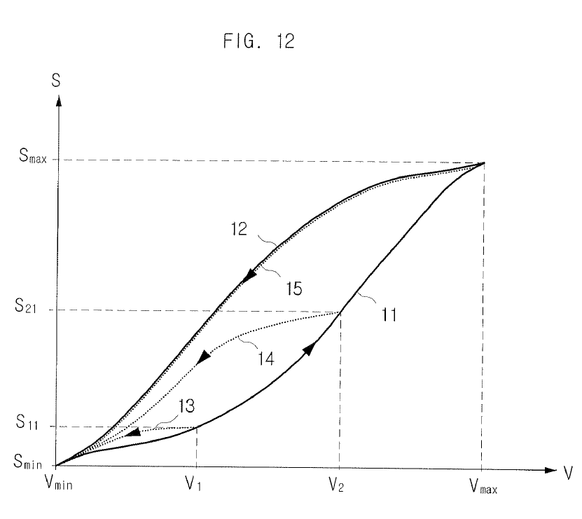

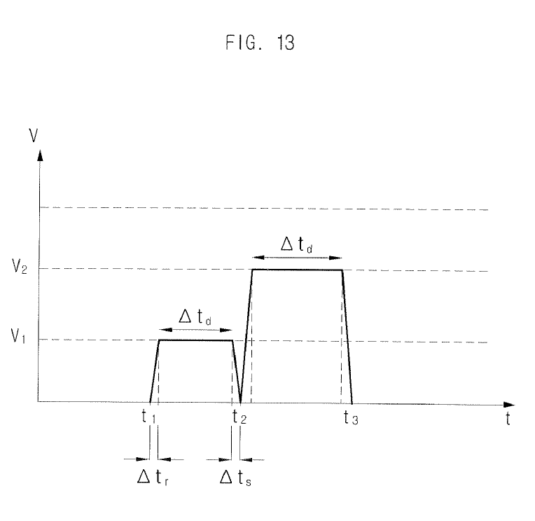

FIG. 11A shows a displacement caused by a displacement object displaced by a piezoelectric element to which the driving voltage of FIG. 10A is supplied, and FIG. 11B shows a displacement caused by a displacement object displaced by a piezoelectric element to which the driving voltage of FIG. 10B is supplied. FIG. 12 shows the hysteresis of a piezoelectric element to which the driving voltage of FIG. 10A is supplied, and FIG. 13 is an enlarged view showing the driving voltage of FIG. 10A.

FIG. 10A shows a wave pattern of the driving voltage supplied to the piezoelectric element 150 included in a piezoelectric driving device (or an optical modulation device) in accordance with an embodiment of the present invention. In other words, the driving voltage can have a predetermined gray-scale voltage value Vₘᵢₙ, V₁, V₂ and Vₘₐₓ (here, Vₘᵢₙ is assumed to be 0V) and have the shape of a square-wave signal which maintains the gray-scale voltage value during a predetermined period of time and is resets to 0V.

The driving voltage can be generated by the driving unit 235 before being supplied to the piezoelectric element 150 (i.e. between the lower electrode 151 and the upper electrode 153). Here, Vₘᵢₙ refers to a minimum voltage value in the range of a driving voltage supplied to the piezoelectric element 150, and Vₘₐₓ refers to a maximum voltage value in the range of the driving voltage.

For example, if it is assumed that the square-wave signal of FIG. 10A is used as the driving voltage in the piezoelectric optical modulator described with reference to FIG. 4 through FIG. 7, each gray-scale of the square-signal generated by the driving unit 235 can be set to correspond to each modulation voltage value to be used for the optical modulation performed by the piezoelectric modulator. The driving unit 235 can also generate a square-wave every predetermined period. At this time, the period of generating the square-wave can be determined to be the same as the time that it takes the piezoelectric optical modulator to perform the optical modulation of 1 pixel, and the driving unit 235 can synchronize the square-wave with the point of time when the piezoelectric optical modulator performs the optical modulation per pixel.

Although FIG. 10A shows the case of generating the driving voltage every period, for example, if at least two adjacent horizontal pixels have the same light intensity when the optical modulation is performed per pixel, it may be unnecessary that the square-wave signal having the same gray-scale voltage value is generated every period, and the driving unit 235 may generate another square-wave signal having a different gray-scale by resetting the square-wave signal in case that the gray-scale voltage value of the square-wave signal is changed.

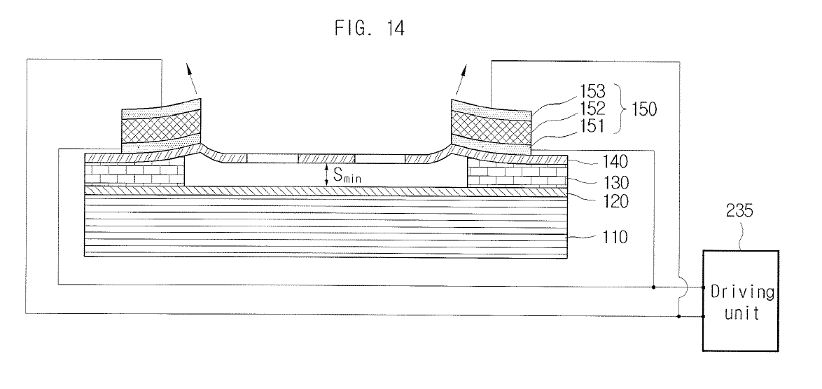

The reset time of the square-wave signal (refer to □tₛ of FIG. 13) can be preferably shorter than the minimum reaction time necessary to cause the displacement object to be displaced according to the supplied driving voltage. This can be more clearly understood through the foresaid FIG. 14 through FIG. 17.

FIG. 11A shows each displacement of the displacement object (hereinafter, is assumed to be the ribbon in the case of the optical modulator of FIG. 4 through FIG. 7) when the square-wave signal of FIG. 10A is supplied to the piezoelectric element 150 through the driving unit 235.

For example, when Sₘᵢₙ is assumed to be ‘0’ by setting the original position of the ribbon without no supplied driving voltage (Vₘᵢₙ=0V), if a first driving voltage having a gray-scale voltage value V₁ is supplied, the displacement of the ribbon refers to S₁₁, and if a second driving voltage having a gray-scale voltage value V₂ is supplied, the displacement of the ribbon refers to S₂₁. If a third driving voltage having a gray-scale voltage value Vₘₐₓ is supplied, the displacement of the ribbon refers to Sₘₐₓ.

Here, in case that the square-wave signal of FIG. 10A and FIG. 10B is supplied unlike the stepped pulse, when the increased or decreased driving voltage is supplied, the displacement can have the same value not different values. This is because the polarization hysteresis of the piezoelectric element can be removed by using the square-wave signal of FIG. 10A, maintaining a gray-scale voltage value during a predetermined period of time and resetting to 0V, as the driving voltage. This can be easily understood through the description with reference to FIG. 12.

Referring to the case of supplying the first driving voltage at a time t₁ of FIG. 10A, the position of the ribbon can be changed according to the first hysteresis curve 11 until the supplied voltage reaches to the gray-scale voltage value (refer to □tᵣ of FIG. 13) and the position of the ribbon can be maintained at the point corresponding to the displacement value S₁₁ if the supplied voltage reaches to the gray-scale voltage value V₁.

At this time, the displacement value S₁₁ can be unchanged while the supplied voltage is maintained as the gray-scale voltage value V₁. Then, if the supplied voltage resets to 0V (refer to □tₛ of FIG. 13), the polarization formed in the piezoelectric layer 152 of the piezoelectric element 150 by the supplied gray-scale voltage value can be restored to the original value (refer to the dotted line having the reference number 13 in FIG. 12) during the reset time of the square-wave signal, to thereby allow the corresponding hysteresis to be removed.

Accordingly, after that, in case that the second driving voltage and the third driving voltage, respectively, are successively increased at the times t₂ and t₃ of FIG. 10A before being supplied (refer to the dotted lines having the reference number 14 and 15 in FIG. 12) and in case that the second driving voltage and the first driving voltage, respectively, are successively decreased at the times t₄ and t₅ of FIG. 10A before being supplied, the piezoelectric layer 152 can have the polarization hysteresis showing the first hysteresis curve 11 of the increased driving voltage of the polarization hysteresis curve. Accordingly, the replacement of the ribbon may have no influence on the polarization hysteresis generated to the piezoelectric element 150 according to the driving voltage supplied before.

Thus, in the case of supplying the square-wave signal of FIG. 10A as the driving voltage to the piezoelectric element 150, as shown in FIG. 11A, the displacement of the ribbon can have the same values regardless of whether the increased driving voltage or the decreased driving voltage is supplied, to thereby providing accuracy and reliability to the driving of the piezoelectric element.

Even though the description with reference to FIG. 10A is focused on the case of resetting the square-wave signal to Vₘᵢₙ, it is naturally possible to use the square-wave signal reset to Vₘₐₓ (e.g. 10V) as the driving voltage as shown in FIG. 10B. If the driving voltage of FIG. 10B is supplied, the polarization hysteresis of the piezoelectric layer 152 can show the second hysteresis curve 12 of the decreased driving voltage of the polarization hysteresis curve of FIG. 12.

Accordingly, as shown in FIG. 11B, the displacement of the ribbon can also have the same values regardless of whether the increased driving voltage or the decreased driving voltage is supplied, to thereby providing accuracy and reliability to the driving of the piezoelectric element.

The description related to FIG. 10A and FIG. 10B showing a total of 4 driving voltages having gray-scale values Vₘᵢₙ, V₁, V₂ and Vₘₐₓ, respectively, is merely an example to describe wave shapes of the driving voltage and the corresponding displacements in accordance with the present invention. Alternatively, it is possible to use the driving voltages that can be divided into as many quantities as the driving voltages for providing the displacements in the quantities which are necessary to apply the piezoelectric driving device or optical modulating device of the present invention.

For example, if the light intensity is assumed to have 0 through 255 values to perform the optical modulation per pixel in the piezoelectric optical modulator described with reference to FIG. 4 through FIG. 7, it is possible to use the driving voltage having a total of 256 gray-scale voltage values. Although since the description with reference to FIG. 10A and FIG. 10B is related to the driving voltage having (+) voltage, the description with reference to FIG. 11A and FIG. 11B is related to the increased position (i.e. the displacement having a (+) value) of the displacement object displaced according to the expansion of the piezoelectric element 150, if the driving voltage having (−) voltage is supplied, it is naturally possible that the position of the displacement object goes down according to the contraction of the piezoelectric element 150, to thereby have a (−) value.

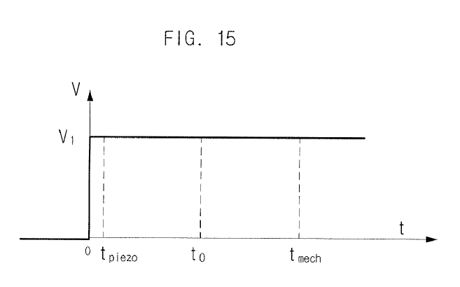

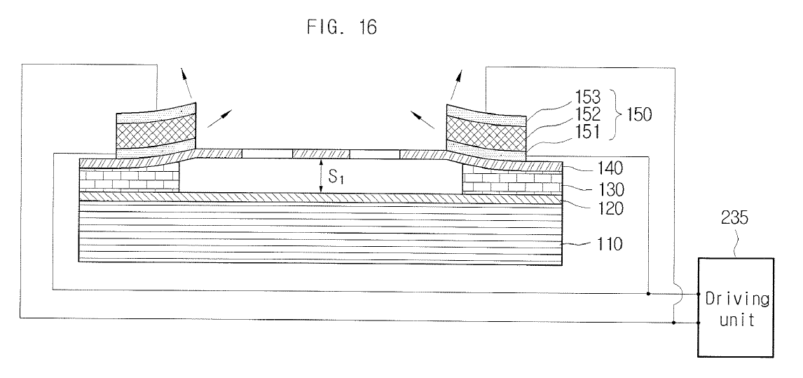

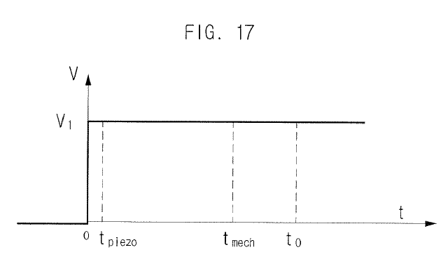

FIG. 14 and FIG. 15 show a maximum reaction time of a piezoelectric element to which a driving voltage is supplied, and FIG. 16 and FIG. 17 show a minimum reaction time of a replacement object when a driving voltage is supplied to a piezoelectric element.

Here, t_{piezo} refers to the maximum reaction (i.e. contraction or expansion) of the piezoelectric element 150 according to a supplied driving voltage, and t_{mech} refers to the minimum reaction (i.e. contraction or expansion) of the piezoelectric element 150 according to a supplied driving voltage. For example, in the case of the optical modulator of FIG. 4 through FIG. 7, the t_{piezo} can be about 0.1 □, and the t_{mech} can be about 1 □.

Accordingly, if the time to of supplying the driving voltage V₁ is under the relationship t_{piezo}<t₀<t_{mech} as shown in FIG. 15, the piezoelectric element 150 can react (i.e. can be expanded due to the supplied (+) voltage) as shown in FIG. 14, but the position (i.e. Sₘᵢₙ) of a ribbon as a displacement object may have been still unchanged.

Unlikely, if the time to of supplying the driving voltage V₁ is under the relationship t₀>t_{mech} as shown in FIG. 17, the ribbon as well as piezoelectric element 150 can react (i.e. increase from Sₘᵢₙ to S₁) as shown in FIG. 17.

This shows that a reset time (refer to □tₛ of FIG. 13) of a square-wave signal, generated by the driving unit 235 and supplied to the piezoelectric element 150 can be shorter than the minimum reaction time t_{mech} necessary to cause the position of the displacement object to be changed according to the supplied driving voltage. For example, in the case of the below-described optical modulator, this is because if the reset time of the square-wave signal has a larger value than t_{mech}, the position of the ribbon may be changed while being reset, to thereby have an influence on the pixel modulation.

Accordingly, it can be preferable that the position change of the ribbon as the displacement object is not largely reflected on the optical modulation during the reset time in order to more accurately perform the optical modulation per pixel. For this, the reset time of the square-wave signal can be preferably shorter than the minimum reaction time of the displacement object.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. An optical modulating device, comprising:
an optical modulator, having a piezoelectric element causing a displacement object to be displaced by being contracted or expanded according to a supplied driving voltage; and
a driving unit, generating the driving voltage to be supplied to the piezoelectric element,
whereas the driving voltage is a square-wave signal has a shorter reset time than a minimum reaction time necessary to allow the displacement object to be displaced.

2. The device of claim 1, wherein the piezoelectric element comprises:
two electrodes; and
a piezoelectric layer, placed between the two electrodes and contracted or expanded according to the driving voltage supplied between the two electrodes,
whereas the piezoelectric layer restores a polarization hysteresis during the reset time and has a property corresponding to any one of directions of a polarization hysteresis curve, the directions having two directions in which the driving voltage is increased and decreased.

3. The device of claim 1, wherein a gray-scale voltage value of the square-wave signal is determined as a modulation voltage value to be used for an optical modulation performed by the optical modulator.

4. The device of claim 1, wherein the square-wave signal is reset whenever a gray-scale voltage value is changed.

5. The device of claim 1, wherein the driving unit generates the square-wave signal at regular intervals of a predetermined period.

6. The device of claim 5, wherein the generating period of the square-wave signal is determined to be identical to a time that it takes for the optical modulator to perform a 1-pixel-optical-modulation.

7. The device of claim 1, wherein the driving unit generates the square-wave signal by synchronizing it with a point of time when an optical modulation is performed per pixel by the optical modulator.

8. The device of claim 1, wherein the minimum reaction time necessary for a displacement of the displacement object is 1 μs.

9. The device of claim 1, wherein the optical modulator comprises:
a substrate;
an insulation layer, placed on the substrate;
a lower optical reflection layer, placed on the insulation layer and reflecting an incident beam of light;
a ribbon layer, having a center part formed with a hole, the center part being away from the insulation layer at a predetermined interval;
an upper optical reflection layer, placed on the center part of the ribbon layer and reflecting the incident beam of light; and
the piezoelectric element, placed on the ribbon layer.

10. The device of claim 9, wherein the displacement object is the center part of the ribbon layer.

11. The device of claim 1, wherein the square-wave signal is reset to a minimum or maximum voltage value in a range of the driving voltage supplied to the piezoelectric element.

12. A piezoelectric driving device, comprising:
a piezoelectric element, causing a displacement object to be displaced by being contracted or expanded according to a supplied driving voltage; and
a driving unit, generating the driving voltage to be supplied to the piezoelectric element,
whereas the driving voltage is a square-wave signal has a shorter reset time than a minimum reaction time necessary to allow the displacement object to be displaced.

13. The device of claim 12, wherein the square-wave signal is reset whenever a gray-scale voltage value is changed.

14. The device of claim 12, wherein the driving unit generates the square-wave signal at regular intervals of a predetermined period.

15. The device of claim 12, wherein the minimum reaction time necessary for a displacement of the displacement object is 1 μs.

16. The device of claim 12, wherein the square-wave signal is reset to a minimum or maximum voltage value in a range of the driving voltage supplied to the piezoelectric element.

17. A method for driving a piezoelectric driving apparatus having a piezoelectric element, which causes a displacement object to be displaced by being contracted or expanded according to a supplied driving voltage, and a driving unit, which generates the driving voltage to be supplied to the piezoelectric element, the method comprising:
generating a square-wave signal having a shorter reset time than a minimum reaction time necessary to allow the displacement object to be displaced; and
supplying the square-wave signal to the piezoelectric element.

18. The method of claim 17, wherein the minimum reaction time necessary for a displacement of the displacement object is 1 μs.
